(19) United States
(12) Patent Application Publication
(10) Pub. No.: US 2014/0186553 A1
(43) Pub. Date: Jul. 3, 2014

(54) POLARIZING PLATE AND OPTICAL DISPLAY INCLUDING THE SAME

(71) Applicant: CHEIL INDUSTRIES INC., Gumi-si (KR)

(72) Inventor: Ri Ra Jung, Uiwang-si (KR)

(73) Assignee: CHEIL INDUSTRIES INC., Gumi-si (KR)

(21) Appl. No.: 14/145,721

(22) Filed: Dec. 31, 2013

(30) Foreign Application Priority Data
Jan. 2, 2013 (KR) 10-2013-0000405

(51) Int. Cl. G02B 1/10

(52) U.S. Cl. CPC G02B 1/10; G02B 1/105
USPC 428/1.31; 428/355 AC; 428/354

(57) ABSTRACT

A polarizing plate and an optical display including the same. The polarizing plate includes a polarizer and an adhesive sheet stacked on one surface of the polarizer, wherein the adhesive sheet includes an adhesive and a reinforcing material impregnated into the adhesive.

### CROSS-REFERENCE TO RELATED APPLICATION

This application claims priority to and the benefit of Korean Patent Application No. 10-2013-0000405, filed on Jan. 2, 2013, in the Korean Intellectual Property Office, the disclosure of which is incorporated herein in its entirety by reference.

### BACKGROUND

1. Field

The following description relates to a polarizing plate and an optical display including the same.

2. Description of the Related Art

Polarizing plates are used for purposes of controlling an oscillation direction of light to visualize display patterns of a liquid crystal display inside and outside a liquid crystal cell. Although the liquid crystal display was only applied to small apparatuses in the initial stages of development, recently, the liquid crystal display is used in a wide range of applications including notebook computers, liquid crystal monitors, liquid crystal color projectors, liquid crystal televisions, navigation systems for vehicles, personal phones, measurement instruments used indoors and outdoors, and the like. Generally, the polarizing plate includes a polarizer and protective films stacked on both sides of the polarizer. As the protective films, triacetyl cellulose (TAC) films have been used. Recently, as a display provided with a polarizing plate becomes thinner, the polarizing plate is also required to become thinner. For this purpose, a polarizing plate without a protective film is being developed.

Moreover, there are attempts to apply a hard adhesive layer exhibiting improved hardness. However, since adhesives are required to have viscoelasticity as well as elasticity and flowability, an adhesive layer alone has limitations (e.g., in providing suitable hardness) when used as a protective film.

Further, if the protective film is omitted, when left under a high temperature or high humidity condition, the polarizing plate may suffer from bubbling or detachment due to distortion (shrinkage or expansion) of the polarizer, thereby deteriorating the durability.

### SUMMARY

In accordance with one embodiment of the present invention, a polarizing plate may include: a polarizer; and an adhesive sheet on one surface of the polarizer, wherein the adhesive sheet may include an adhesive and a reinforcing material impregnated into the adhesive.

In accordance with another embodiment of the present invention, an optical display may include: a liquid crystal panel; and a polarizing plate on the liquid crystal panel.

### BRIEF DESCRIPTION OF THE DRAWINGS

FIG. 1 is a cross-sectional view of a polarizing plate according to one embodiment of the present invention.

FIG. 2 is a cross-sectional view of a polarizing plate according to another embodiment of the present invention.

FIG. 3 is a cross-sectional view of a structure in which a polarizing plate is stacked on a liquid crystal panel.

FIG. 4 is a schematic cross-sectional view of an optical display according to one embodiment of the present invention.

FIG. 5 shows a pellicle of bacterial cellulose.

FIG. 6 is a scanning electron microscope (SEM) image of a portion of FIG. 5.

FIG. 7 is an SEM image of cellulose prepared from a culture of bacteria.

FIG. 8 shows a dried bacterial cellulose sheet.

FIG. 9 shows a bacterial cellulose sheet coated with an adhesive.

FIG. 10 is a cross-sectional view of a polarizing plate of Comparative Examples 1-4.

### DETAILED DESCRIPTION

Hereinafter, embodiments of the present invention will be described in more detail with reference to the accompanying drawings. It should be understood that the present invention may be embodied in different ways and is not limited to the following embodiments. In the drawings, elements irrelevant to the description will be omitted for clarity. Like components will be denoted by like reference numerals throughout the specification. As used herein, terms such as “upper side” and “lower side” are defined with reference to the accompanying drawings. Thus, it will be understood that the term “upper side” may be used interchangeably with the term “lower side”. The term “(meth)acrylate” may refer to acrylates and/or methacrylates. Expressions such as “at least one of,” when preceding a list of elements, modify the entire list of elements and do not modify the individual elements of the list. Further, the use of “may” when describing embodiments of the present invention refers to “one or more embodiments of the present invention.”

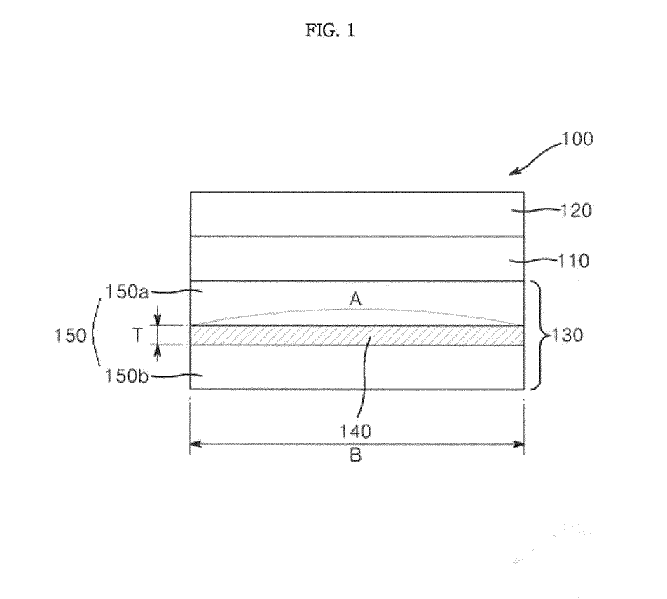

Hereinafter, a polarizing plate according to one embodiment of the invention will be described in more detail with reference to FIG. 1. FIG. 1 is a cross-sectional view of a polarizing plate according to one embodiment of the present invention.

Referring to FIG. 1, a polarizing plate 100 according to one embodiment of the invention may include: a polarizer 110; a protective film 120 formed on an upper side of the polarizer 110; and an adhesive sheet 130 formed on a lower side of the polarizer 110, wherein the adhesive sheet 130 may include an adhesive 150 and a reinforcing material 140 impregnated into the adhesive 150.

The polarizer 110 may be prepared from a polyvinyl alcohol film. In one embodiment, the polyvinyl alcohol film may be any suitable polyvinyl alcohol film regardless of the preparation methods. For example, the polyvinyl alcohol film may be a modified polyvinyl alcohol film, such as a partially formalized polyvinyl alcohol film, an acetoacetyl group-modified polyvinyl alcohol film, or the like.

The polarizer 110 may be prepared by dyeing a polyvinyl alcohol film with iodine or a dichroic dye, followed by stretching in a certain direction. For example, the polarizer may be prepared through swelling, dyeing, and stretching (elongation). Each process may be performed by a suitable method generally known in the art. In one embodiment, a stretching ratio may range from about 3 times to about 7 times an initial length of the film. After stretching, the polarizer may also be subjected to cross-linking treatment with boric acid and potassium iodide.

The polarizer 110 may have a thickness from about 5 μm to about 40 μm, without being limited thereto.

The polarizer 110 may further include a functional film or functional layer stacked on an upper or lower side thereof, thereby imparting an additional function to the polarizer. For example, the polarizer 110 may further include an anti-reflective layer, a hard coating layer or the like, which is typically known in the art.

The protective film 120 is stacked on the upper side of the polarizer 110 and may protect the polarizer from an external environment. The protective film may be bonded to the polarizer using a suitable (e.g., a typical) water-based bonding agent.

The protective film 120 may be any suitable transparent film without limitation. For example, the protective film may be formed of celluloses (for example, triacetyl cellulose (TAC) or the like), cyclic polyolefins (for example, amorphous cyclic olefin polymers (COPs) or the like), poly(meth)acrylates (for example, polymethyl methacrylate or the like), polycarbonates, polyesters (for example, polyethylene terephthalate (PET) or the like), polyethersulfones, polysulfones, polyamides, polyimides, polyolefins, polyarylates, polyvinyl alcohols, polyvinyl chlorides, polyvinylidene chlorides, or mixtures thereof.

The protective film 120 may have a thickness from about 1 μm to about 200 μm, for example, from about 3 μm to about 80 μm, without being limited thereto. Within this range, the protective film may be (suitable to be) applied to the polarizing plate.

The protective film 120 may further include an anti-reflective layer, a hard coating layer or the like on an upper side thereof, that is, on a surface of the protective film which does not contact the polarizer 110. The anti-reflective layer, the hard coating layer or the like may be a suitable (e.g., a typical) one known to those skilled in the art.

The adhesive sheet 130 may include the adhesive 150 and the reinforcing material 140 impregnated into the adhesive 150. Since the adhesive sheet 130 exhibits adhesion on both surfaces thereof in a thickness direction, the adhesive sheet 130 may be bonded to both the polarizer and a liquid crystal panel.

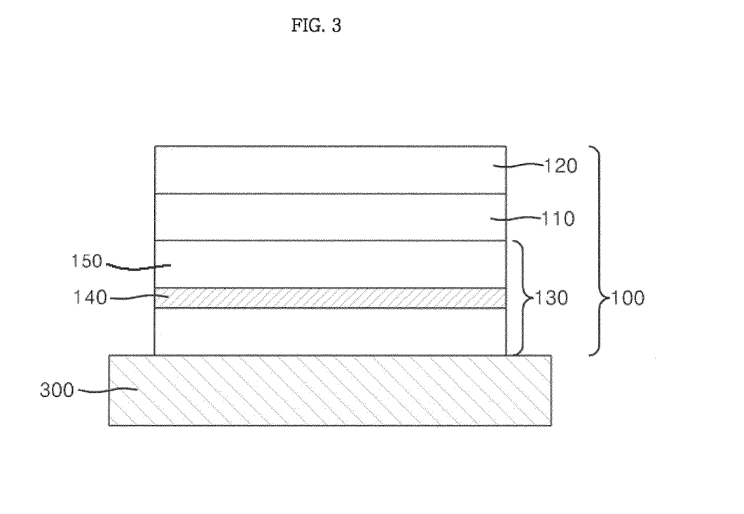

FIG. 3 is a cross-sectional view of a structure in which a polarizing plate is stacked on a liquid crystal panel. Referring to FIG. 3, a polarizing plate 100 may include: a polarizer 110; a protective film 120 stacked on an upper side of the polarizer 110; and an adhesive sheet 130 stacked on a lower side of the polarizer 110, wherein the adhesive sheet 130 may include an adhesive 150 and a reinforcing material 140 impregnated into the adhesive 150, and the polarizing plate 100 may be directly stacked on a liquid crystal panel 300 via the adhesive sheet 130. As shown in FIG. 3, the polarizing plate may be stacked on the liquid crystal panel via the adhesive sheet without a protective film, and the adhesive sheet serves as a protective film while exhibiting a suitable adhesion, whereby the thickness of the polarizing plate may be reduced.

The adhesive 150 may provide adhesion to the adhesive sheet and may be a suitable (e.g., a typical) adhesive providing adhesion. The adhesive 150 may exhibit appropriate wettability and excellent properties in terms of optical transparency, coherence, adhesion, weather resistance, and heat resistance. For example, the adhesive may include at least one selected from among rubber adhesives, (meth)acrylic adhesives, silicone adhesives, urethane adhesives, vinyl alkyl ether adhesives, polyvinyl alcohol adhesives, polyvinyl pyrrolidone adhesives, polyacrylamide adhesives, and cellulose adhesives. For example, the adhesive may include (meth)acrylic adhesives.

For example, the adhesive may be formed of (a reaction product of) a composition including: a (meth)acrylic copolymer, which is a polymerization reaction product of a mixture including an alkyl group-containing (meth)acrylic monomer, a carboxylic acid group-containing (meth)acrylic monomer, and a hydroxyl group-containing (meth)acrylic monomer; and a cross-linking agent.

The alkyl group-containing (meth)acrylic monomer may include a C₁ to C₁₆ linear or branched unsubstituted alkyl group-containing (meth)acrylic acid ester. For example, the alkyl group-containing (meth)acrylic monomer may include at least one selected from among methyl (meth)acrylate, ethyl (meth)acrylate, propyl (meth)acrylate, n-butyl (meth)acrylate, t-butyl (meth)acrylate, iso-butyl (meth)acrylate, pentyl (meth)acrylate, hexyl (meth)acrylate, 2-ethylhexyl (meth)acrylate, heptyl (meth)acrylate, octyl (meth)acrylate, iso-octyl (meth)acrylate, nonyl (meth)acrylate, and decyl (meth)acrylate, without being limited thereto.

The carboxylic acid group-containing (meth)acrylic monomer may include at least one selected from among (meth)acrylic acid and β-carboxyethyl (meth)acrylate, without being limited thereto.

The hydroxyl group-containing (meth)acrylic monomer may be a C₂ to C₂₀ alkyl group-containing (meth)acrylic acid ester having a hydroxyl group at a terminal or in a structure thereof. For example, the hydroxyl group-containing (meth)acrylic monomer may include at least one selected from among 2-hydroxyethyl (meth)acrylate, 2-hydroxypropyl (meth)acrylate, 2-hydroxybutyl (meth)acrylate, 4-hydroxybutyl (meth)acrylate, 6-hydroxyhexyl (meth)acrylate, 1,4-cyclohexanedimethanol mono(meth)acrylate, 1-chloro-2-hydroxypropyl (meth)acrylate, diethyleneglycol mono(meth)acrylate, 1,6-hexanediol mono(meth)acrylate, pentaerythritol tri(meth)acrylate, dipentaerythritol penta(meth)acrylate, neopentylglycol mono(meth)acrylate, trimethylolpropane di(meth)acrylate, trimethylolethane di(meth)acrylate, 2-hydroxy-3-phenyloxypropyl (meth)acrylate, 4-hydroxycyclopentyl (meth)acrylate, 4-hydroxycyclohexyl (meth)acrylate, and cyclohexanedimethanol mono(meth)acrylate, without being limited thereto.

The (meth)acrylic copolymer may be a copolymer of a polymerization reaction product of a mixture comprising about 95 percent by weight (wt %) to about 98.5 wt % (for example, about 95, 96, 97, 98 or 98.5 wt %) of the alkyl group-containing (meth)acrylic monomer, about 2 wt % to about 5 wt % (for example, about 2, 3, 4 or 5 wt %) of the carboxylic acid group-containing (meth)acrylic monomer, and about 2 wt % to about 5 wt % (for example, about 2, 3, 4 or 5 wt %) of the hydroxyl group-containing (meth)acrylic monomer. Within this range, the adhesive may provide reliability for polarizing films and adhesion thereto. For example, the (meth)acrylic copolymer may be a copolymer of a polymerization reaction product of a mixture comprising about 95 wt % to about 96 wt % of the alkyl group-containing (meth)acrylic monomer, about 2 wt % to about 3 wt % of the carboxylic acid group-containing (meth)acrylic monomer, and about 2 wt % to about 3 wt % of the hydroxyl group-containing (meth)acrylic monomer.

The (meth)acrylic copolymer may have a weight average molecular weight from about 1,000,000 g/mol to about 1,500,000 g/mol, for example, 1000000, 1100000, 1200000, 1300000, 1400000 or 1500000 g/mol. Within this range, the adhesive may realize reliability for polarizing films and adhesion thereto.

The (meth)acrylic copolymer may be prepared by any suitable (e.g., a typical) preparation method. For example, the (meth)acrylic copolymer may be prepared by adding an initiator to a mixture of monomers, followed by polymerization.

The cross-linking agent may include at least one selected from the group consisting of isocyanate curing agents, carbodiimide curing agents, epoxy curing agents, aziridine curing agents, melamine curing agents, amine curing agents, imide curing agents, and amide curing agents.

The cross-linking agent may be present in an amount of about 0.1 parts by weight to about 10 parts by weight, for example, about 0.1 parts by weight to about 9 parts by weight based on 100 parts by weight of the (meth)acrylic copolymer. Within this range, the adhesive may exhibit improved adhesion.

The adhesive may further include a silane coupling agent. The silane coupling agent may be present in an amount of about 0.01 parts by weight to about 5 parts by weight based on 100 parts by weight of the (meth)acrylic copolymer. Within this range, the adhesive may exhibit excellent adhesion to the liquid crystal panel, and the (meth)acrylic copolymer may exhibit excellent storage stability. The silane coupling agent may be, for example, present in an amount of about 0.01 parts by weight to about 1 part by weight, or about 0.01 parts by weight to about 0.5 parts by weight based on 100 parts by weight of the (meth)acrylic copolymer.

The silane coupling agent may be any suitable (e.g., a typical) one known to those skilled in the art. For example, the silane coupling agent may be alkoxy (for example, C₁ to C₅ alkoxy) silane having an epoxy moiety, such as 3-glycidoxypropyltrimethoxysilane, 3-glycidoxypropylmethyldimethoxysilane, 2-(3,4-epoxycyclohexyl)ethyltrimethoxysilane, or the like.

The adhesive may be present in an amount of about 50 wt % to about 99.5 wt %, for example, about 80 wt % to about 99.5 wt % in the adhesive sheet. Within this range, the adhesive sheet may exhibit improved durability while securing sufficient adhesion.

The adhesive 150 may include a first adhesive 150a interposed between the polarizer 110 and the reinforcing material 140, and a second adhesive 150b interposed between the reinforcing material 140 and a lower side of the adhesive sheet. The first and second adhesives 150a, 150b may be the same or different. In addition, the first and second adhesives 150a, 150b may have the same or different degrees of softness, which corresponds to storage modulus.

The reinforcing material 140 may be included in the adhesive sheet and suppresses distortion (shrinkage or expansion) of the polarizer and thus allows the adhesive sheet to have the same effects as those of existing protective films. As a result, since the polarizing plate according to embodiments of the present invention may be directly stacked on the liquid crystal panel via the adhesive sheet without the protective film and does not suffer from bubbling, detachment or the like at high temperature and high humidity, the polarizing plate may exhibit improved durability. In addition, the reinforcing material 140 may reduce or prevent sublimation of iodine inside the polarizer.

The reinforcing material 140 may include reinforcing fibers or a fibrous network of reinforcing fibers. The fibers may provide high durability despite small diameter thereof and enable reduction in thickness of the polarizing plate. For example, since the fibrous network includes a complicated connection relation of fibers, the fibrous network may improve the durability, provide a polarizing plate suitable for being attached to a large panel, and reduce or prevent sublimation of iodine inside the polarizer.

The fibers may have a diameter of a wavelength of visible light (for example, about 380 nm to about 780 nm) or less. Within this range, the fibers included in the adhesive sheet are not visible, do not deteriorate transmittance of the polarizing plate, and are transparent.

In one embodiment, the fibers have a diameter of about 380 nm or less, for example, from about 50 nm to about 380 nm. Within this range, the fibers may realize effects of the reinforcing material when included in the adhesive sheet.

The fibers may include at least one selected from among cellulose fibers, glass fibers, carbon fibers, cotton fibers, and carbon nanotube fibers. These may be used alone or in combination thereof. In one embodiment, the fibers may include cellulose fibers, and the reinforcing material may be a cellulose sheet.

In one embodiment, the cellulose sheet may be a bacterial cellulose sheet and may be obtained from a cellulose-containing gel obtained from a culture of bacteria. For example, the reinforcing material may be prepared by removing bacterial component from a culture obtained by culturing bacteria to obtain a cellulose-containing gel, followed by drying the cellulose-containing gel. The reinforcing material prepared through such a process may be a cellulose sheet and have a form in which cellulose fibers are networked. To obtain a desired shape of the fibers and desired thickness and shape of the reinforcing material, the shape of an incubator of bacteria, the culture period, and the like may be suitably adjusted.

The reinforcing material may be any suitable material without limitation so long as the material includes fibers or a fibrous network. In one embodiment, the reinforcing material may have a form of sheets, particles, films, or the like. For example, the reinforcing material may be included in a sheet form in consideration of durability, preparation methods, and the like.

The reinforcing material may have a thickness from about 50 nm to about 100 μm. Within this range, the reinforcing material is not visible when included in the adhesive sheet, and does not affect transmittance of the polarizing plate. For example, the reinforcing material may have a thickness from about 0.05 μm to about 20 μm, or from about 0.1 μm to about 10 μm.

A ratio of the maximum length of the reinforcing material 140 to the length of the adhesive sheet 130 (i.e. the maximum length of the reinforcing material 140/the length of the adhesive sheet 130, for example, a maximum length of the reinforcing material 140 along one direction to the length of the adhesive sheet 130 along the same direction) may be about 1 or less, for example, from about 0.8 to about 1, or about 0.8, 0.9 or 1. Referring to FIG. 1, the ratio (A/B) of the maximum length (A) of the reinforcing material 140 to the length (B) of the adhesive sheet 130 may be 1.

Although the polarizing plate is illustrated as including the reinforcing material 140 disposed in one direction of the adhesive sheet in FIG. 1, the reinforcing material may be placed in any direction of the adhesive sheet. In one embodiment, the reinforcing material may be disposed inside the adhesive sheet, or at a position contacting the polarizer.

When the reinforcing material has a sheet shape, the reinforcing material may be included in the adhesive sheet as a single layer or multiple layers. The term “single layer” refers to a case where no bonding agent or the like is included in the reinforcing material layer, even if a plurality of layers are included in the reinforcing material (i.e., the plurality of layers are not bonded to each other via any bonding agent or the like therebetween), and that the plurality of layers have the same components.

The reinforcing material having a sheet shape may have a thickness (T) from about 50 nm to about 20 μm. Within this range, the reinforcing material may be used in the polarizing plate and enables reduction in thickness of the polarizing plate.

The adhesive sheet may have a total thickness from about 3 μm to about 100 μm, for example, from about 5 μm to about 50 μm, or from about 5 μm to about 30 μm. Within this range, the adhesive sheet may be used in the polarizing plate and enables reduction in thickness of the polarizing plate.

Despite impregnation of the reinforcing material, the adhesive sheet may have a high transparency. In one embodiment, the adhesive sheet may have a transparency of about 90% or more, for example, from about 90% to about 99% at a wavelength from 300 nm to 780 nm. Within this range, the adhesive sheet may be suitable to be applied to the polarizing plate.

The reinforcing material may be present in an amount of about 0.5 wt % to about 50 wt %, for example, about 0.5 wt % to about 20 wt %, or about 1 wt % to about 10 wt % in the adhesive sheet. Within this range, the adhesive sheet may exhibit improved durability while securing sufficient adhesion.

The adhesive sheet may be prepared by a suitable (e.g., a typical) method using the adhesive and the reinforcing material.

In one embodiment, the adhesive may be coated onto both surfaces of the reinforcing material, thereby preparing an adhesive sheet exhibiting adhesion on both surfaces thereof. The adhesive may be coated by a suitable (e.g., a typical) coating method. In one embodiment, the adhesive may be coated by at least one method selected from among reverse coating, roll coating (for example, gravure coating or the like), spin coating, screen coating, fountain coating, dip coating, and spray coating.

In another embodiment, the adhesive sheet may be prepared by dipping the reinforcing material into the adhesive.

In a further embodiment, the adhesive sheet may be prepared by coating the adhesive onto a release sheet, followed by transferring the adhesive to the reinforcing material.

The adhesive may be used in the form of a solution, in which a composition for an adhesive is dissolved or dispersed in a suitable (e.g., a typical) solvent. In one embodiment, the solvent may include at least one selected from among toluene, ethyl acetate, and methylethylketone. These solvents may be used alone or in combination thereof. In the solution, the composition for an adhesive may be present in an amount of about 10 wt % to about 40 wt % based on the total weight of the solution (i.e., the total weight of the adhesive and the solvent).

The polarizing plate may be prepared by laminating the adhesive sheet on the polarizer, followed by a suitable (e.g., a typical) aging process (e.g., curing process) of the adhesive. In one embodiment, aging of the adhesive may be performed at about 35° C. to about 40° C. and at about 45% RH (relative humidity) to about 50% RH.

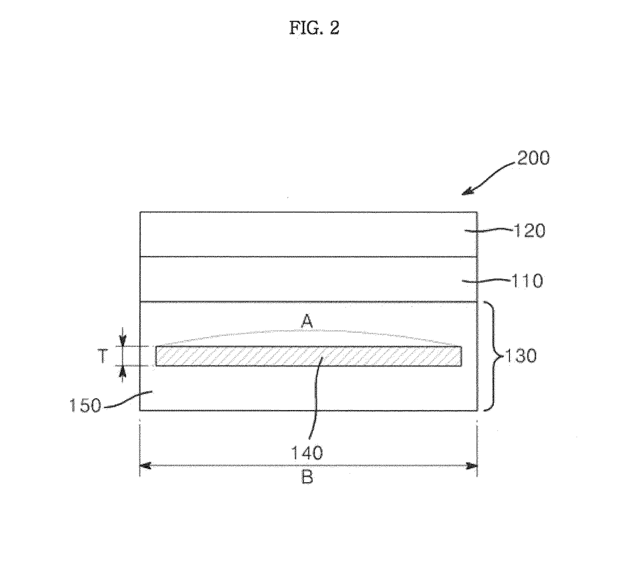

Hereinafter, a polarizing plate according to another embodiment of the invention will be described in more detail with reference to FIG. 2. FIG. 2 is a cross-sectional view of a polarizing plate according to another embodiment of the present invention. Referring to FIG. 2, a polarizing plate 200 according to this embodiment may include: a polarizer 110; a protective film 120 stacked on an upper side of the polarizer 110; and an adhesive sheet 130 stacked on a lower side of the polarizer 110, wherein the adhesive sheet 130 may include an adhesive 150 and a reinforcing material 140 impregnated into the adhesive 150, and a ratio (A/B) of the maximum length (A) of the reinforcing material 140 to the length (B) of the adhesive sheet 130 may range from about 0.8 to less than about 1. The polarizing plate 200 is substantially the same as the polarizing plate of FIG. 1 except that the adhesive sheet has a ratio (A/B) from about 0.8 to less than about 1.

The adhesive sheet for polarizing plates according to this embodiment of the invention may include the adhesive and the reinforcing material impregnated into the adhesive.

Details of the adhesive, the reinforcing material and the adhesive sheet are as described above. The adhesive sheet for polarizing plates includes the reinforcing material while exhibiting a suitable adhesion, and thus may provide a suitable durability.

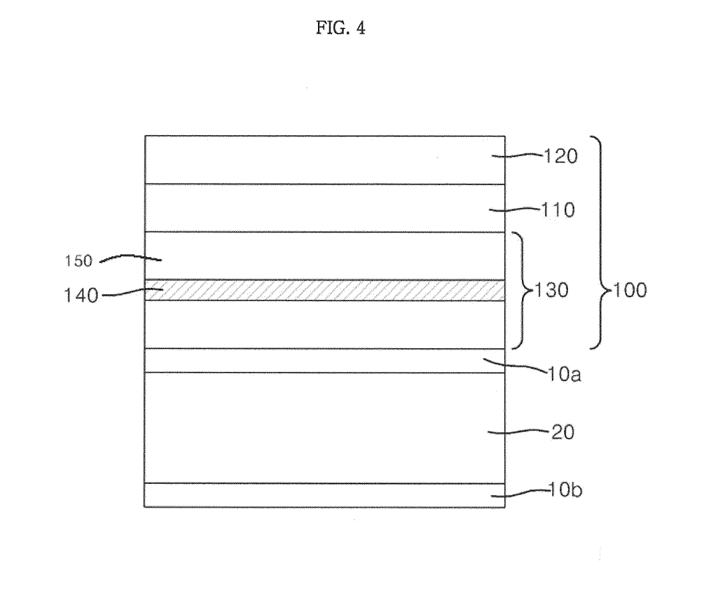

An optical display according to one embodiment of the invention includes the polarizing plate according to embodiments of the present invention, and will be described in more detail with reference to FIG. 4. FIG. 4 is a schematic sectional view of an optical display according to one embodiment of the present invention.

Referring to FIG. 4, an optical display may include: a first substrate 10a; a second substrate 10b facing the first substrate 10a; a liquid crystal panel including a liquid crystal layer 20 sealed between the first substrate 10a and the second substrate 10b; and a polarizing plate 100 according to one embodiment of the invention formed on an upper surface of the first substrate 10a.

The first substrate (e.g., the upper substrate) 10a may be a color filter (CF) substrate and the second substrate (e.g., the lower substrate) 10b may be a thin film transistor (TFT) substrate, without being limited thereto.

Each of the first substrate 10a and the second substrate 10b may be a glass or plastic substrate. The plastic substrate may include polyethylene terephthalate (PET), polycarbonate (PC), polyimide (PI), polyethylene naphthalate (PEN), polyether sulfone (PES), polyarylate (PAR), cycloolefin copolymer (COC) substrates, or the like, without being limited thereto.

The polarizing plate 100 according to this embodiment of the invention may be stacked on an upper side of the first substrate 10a. In addition, although not shown in FIG. 4, the polarizing plate 100 according to this embodiment of the invention may also be stacked on a lower side of the second substrate 10b.

Next, embodiments of the present invention will be described in more detail with reference to some examples. It should be understood that these examples are provided for illustration only and are not to be construed in any way as limiting the scope of the present invention.

### Preparative Example 1

### Preparation of a Cellulose Sheet

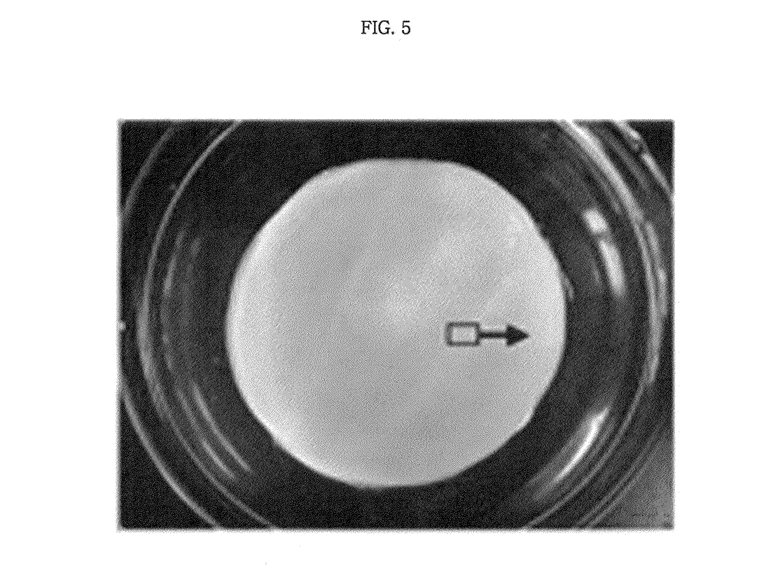

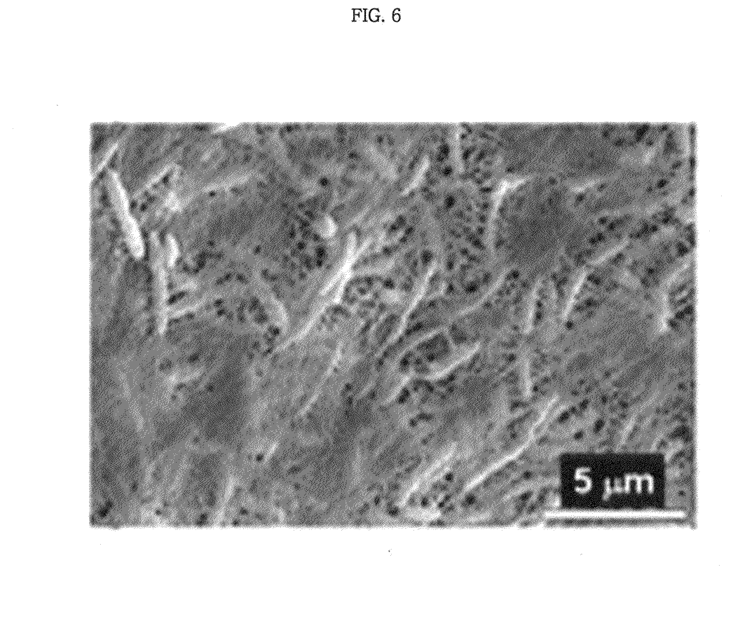

A cellulose sheet was prepared using acetobacter xylinum (Gluconacetobactor xylinum BRC 5, Yonsei Univ.). After 5 ml to 10 ml of a Hestrin & Schramm culture medium was placed in a Petri dish, 50 μl of a culture fluid was provided to the culture medium, followed by stationary culture in an incubator at 30° C. for 3 days to 7 days such that a sheet having a desired thickness was created, thereby preparing a cellulose sheet as shown in FIG. 5. From an observation result of a portion of FIG. 5, it could be seen that microbial cells mixed with cellulose fibers were obtained, as shown in FIG. 6.

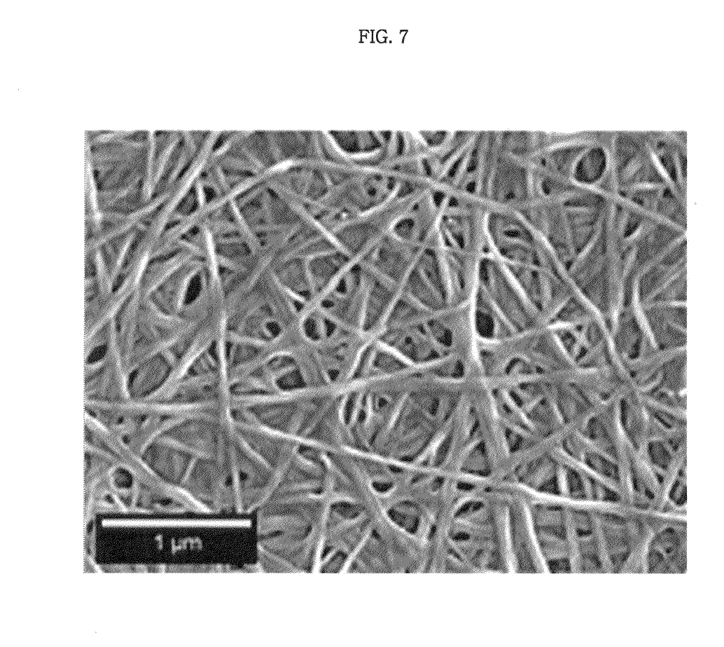

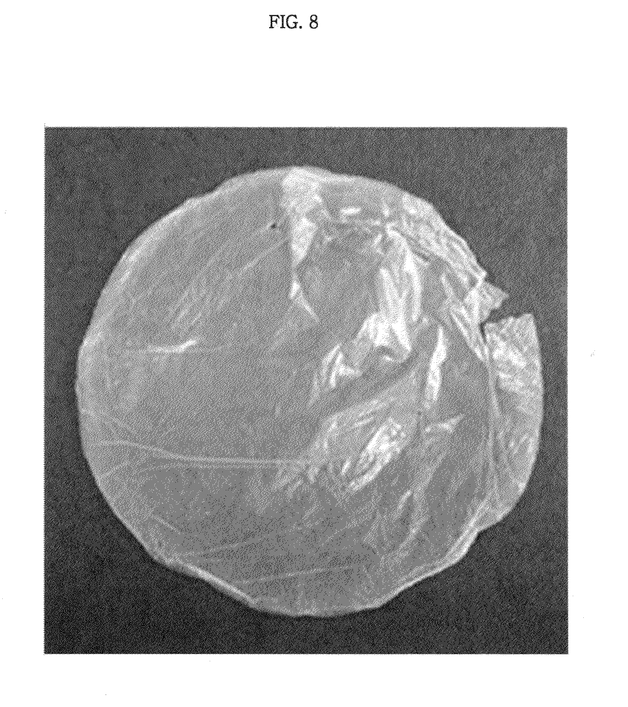

After culturing, the cellulose was prepared in a gel state. The cellulose was washed with distilled water, followed by dipping the cellulose into a 0.25 M NaOH solution for 48 hours to remove the bacteria component therefrom. To improve the efficiency of elution of the bacteria component, the NaOH solution was replaced at a time point after each of 3, 6, 12, 24 and 48 hours. Then, the cellulose was washed again with distilled water several times, thereby neutralizing the cellulose to have a pH of 7. The purified cellulose gel was dried at room temperature, thereby obtaining cellulose in a sheet form. FIG. 7 shows an SEM image of a surface of the bacterial cellulose after purification. The dried cellulose sheet had a thickness of 5 μm. FIG. 8 shows the dried cellulose sheet.

### Preparative Example 2

### Preparation of Adhesive I

100 parts by weight of an acrylic adhesive resin, which was prepared by copolymerization of 95 parts by weight of a C₁ to C₁₆ alkyl group-containing monomer (butyl acrylate), 2.5 parts by weight of a carboxylic acid group-containing monomer (acrylic acid), and 2.5 parts by weight of a hydroxyl group-containing monomer (2-hydroxyethyl methacrylate) to have an average molecular weight of 1,000,000 g/mol; 20 parts by weight of methylethylketone as a diluent; 0.5 parts by weight of an adduct of diisocyanate with trimethylolpropane as a cross-linking agent; and 0.06 parts by weight of epoxy moiety-containing methoxysilane as a coupling agent were mixed, followed by stirring the mixture for 20 minutes, thereby preparing an adhesive coating solution.

Next, the coating solution was coated onto a release film, followed by drying, thereby preparing an adhesive sheet having a 25 μm thick adhesive layer. The adhesive sheet was laminated on a polarizing plate, and left at 35° C. and 45% RH.

The adhesive stacked to a thickness of 1 mm was cut into a circular specimen having a diameter of 8 mm. Storage modulus (G′) of the specimen was measured using a tester MCR-501 (Physica Co., Ltd.) through frequency sweep testing at 25° C. by oscillation at an angular velocity from 10⁻³ Hz to 10² Hz. The adhesive had a storage modulus of 1×10⁴ Pa at 1 Hz.

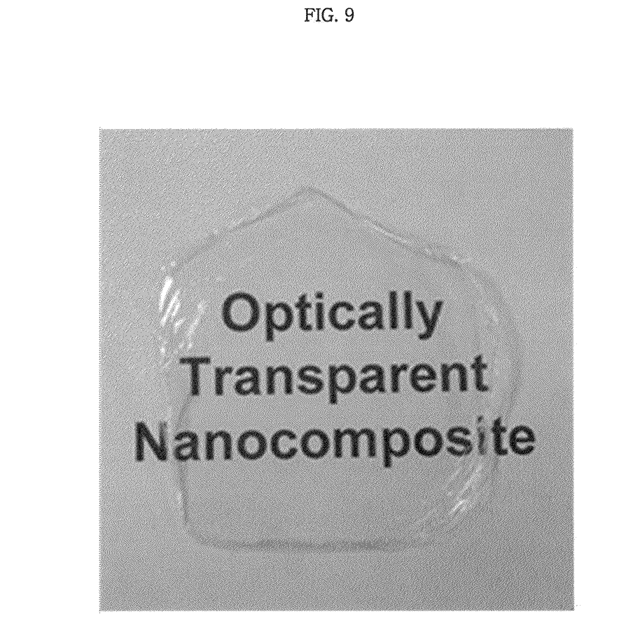

From results after coating the adhesive onto the cellulose sheet of Preparative Example 1, it could be seen that the adhesive-coated cellulose sheet was transparent, as shown in FIG. 9.

### Preparative Example 3

### Preparation of Adhesive II

100 parts by weight of an acrylic adhesive resin, which was prepared by copolymerization of 96 parts by weight of a C₁ to C₁₆ alkyl group-containing monomer (butyl acrylate), 2 parts by weight of a carboxylic acid group-containing monomer (acrylic acid), and 2 parts by weight of a hydroxyl group-containing monomer (2-hydroxyethyl methacrylate) to have an average molecular weight of 1,500,000 g/mol; 20 parts by weight of methylethylketone as a diluent; 8 parts by weight of an adduct of diisocyanate with trimethylolpropane; 0.003 parts by weight of carbodiimide as a cross-linking agent; and 0.06 parts by weight of epoxy moiety-containing methoxysilane as a coupling agent were mixed, followed by stirring the mixture for 20 minutes, thereby preparing an adhesive coating solution. The coating solution was coated onto a release film, followed by drying, thereby preparing an adhesive sheet having a 25 μm thick adhesive layer. Next, the adhesive sheet was laminated onto a polarizing plate, and left at 35° C. and 45% RH.

Storage modulus was measured in the same manner as in Preparative Example 2, and the adhesive had a storage modulus of 1×10⁷ Pa.

### Preparative Example 4

### Preparation of a Polarizer

While being moved on a guide roll, a polyvinyl alcohol film was dyed by dipping in a dyeing solution of iodine and potassium iodide, followed by stretching to a length of 3 times to 5 times an initial length thereof. Next, the film was introduced into a tank containing boric acid and potassium iodide to be cross-linked, followed by drying at 80° C. for 5 minutes to 8 minutes, thereby preparing a polarizer.

### Example 1

As a protective film, a triacetyl cellulose film was bonded to one surface of the polarizer of Preparative Example 4 using a water-based bonding agent, followed by lamination. The adhesive of Preparative Example 2 as an upper adhesive was coated onto one surface of the cellulose sheet of Preparative Example 1, and the adhesive of Preparative Example 3 as a lower adhesive was coated onto the other surface of the cellulose sheet of Preparative Example 1, thereby preparing an adhesive sheet exhibiting adhesion on both surfaces thereof. The adhesive sheet was laminated on the other surface of the polarizer, and aged at 35° C. and 45% RH, thereby preparing a polarizing plate having a structure of FIG. 1.

### Example 2

A protective film was bonded to one surface of the polarizer of Preparative Example 4 using a water-based bonding agent, followed by lamination. The cellulose sheet of Preparative Example 1 was dipped into the adhesive of Preparative Example 2, thereby preparing an adhesive sheet. The adhesive sheet was laminated on the other surface of the polarizer, and aged at 35° C. and 45% RH, thereby preparing a polarizing plate having a structure of FIG. 2.

### Examples 3 to 6

Polarizing plates were prepared in the same manner as in Examples 1 to 2 except that the type of adhesive and the structure of the polarizing plate were changed as listed in Table 1.

### Comparative Examples 1 to 4

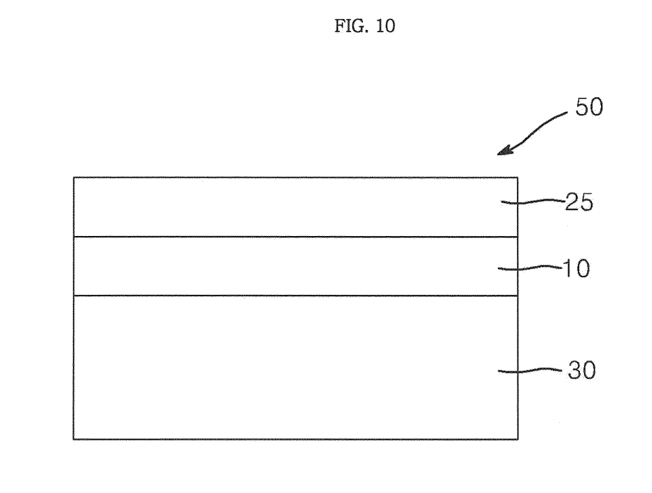

Polarizing plates were prepared in the same manner as in Examples 1 to 2 except that the type of adhesive and the structure of the polarizing plate were changed as listed in Table 1. Referring to FIG. 10, a polarizing plate 50 includes: a polarizer 10; a protective film 25 stacked on an upper side of the polarizer; and an adhesive layer 30 stacked on a lower side of the polarizer.

Durability was evaluated on the prepared polarizing plates. A specimen of each of the polarizing plates, which had a size of 100 mm×80 mm, was attached to a liquid crystal display or a glass substrate, and pressed at 50° C. and 3.5 atmosphere (atm). Next, the specimen was kept under dry heat conditions of 85° C. for 500 hours and then under wet heat conditions of 60° C. and 90% RH for 500 hours, and left at room temperature for 1 hour, followed by observing the polarizing plate for any detachment at an end thereof and bubbling. The polarizing plate was rated according to the following evaluation criteria.

O: neither detachment at an end nor bubbling

X: both detachment at an end and bubbling

TABLE 1

| | Example | | | | | | Comparative Example | | | |
|---|---|---|---|---|---|---|---|---|---|---|
| | 1 | 2 | 3 | 4 | 5 | 6 | 1 | 2 | 3 | 4 |
| Structure of | FIG. | FIG. | FIG. | FIG. | FIG. | FIG. | FIG. | FIG. | FIG. | FIG. |
| polarizing plate | 1 | 2 | 1 | 2 | 1 | 1 | 10 | 10 | 10 | 10 |
| Type of | I | I | II | II | II | I | I | II | II | I |
| upper | | | | | | | | | | |
| adhesive | | | | | | | | | | |
| Type of lower | I | I | II | II | I | II | I | II | I | II |
| adhesive | | | | | | | | | | |
| Durability | ◯ | ◯ | ◯ | ◯ | ◯ | ◯ | X | X | X | X |

In Table 1, it can be observed that the polarizing plates including the adhesive sheet according to embodiments of the invention exhibited improved durability since the cellulose sheet served as a reinforcing material. Such durability could also improve other properties of the adhesive sheet in terms of light leakage, warpage, or the like, which are required (necessary) for the final products. Thus, embodiments of the present invention provided a polarizing plate that may be attached to a panel without a protective film. The polarizing plate may have (or realize) sufficient durability even under high temperature and high humidity conditions, and have a reduced thickness, since the polarizing plate includes an adhesive sheet capable of providing (realizing) both a suitable adhesion and the function of a protective film.

Conversely, the polarizing plates of Comparative Examples 1 to 4 suffered from detachment and thus exhibited poor durability since the adhesive layers thereof did not endure shrinkage of the polarizer.

While the present invention has been particularly shown and described with reference to example embodiments thereof, it will be understood by those of ordinary skill in the art that various changes in form and details may be made therein without departing from the spirit and scope of the present invention as defined by the following claims, and equivalents thereof.

What is claimed is:

1. A polarizing plate comprising:
a polarizer; and
an adhesive sheet on one surface of the polarizer,
wherein the adhesive sheet comprises an adhesive and a reinforcing material impregnated into the adhesive.

2. The polarizing plate according to claim 1, wherein the adhesive comprises at least one selected from the group consisting of rubber adhesives, (meth)acrylic adhesives, silicone adhesives, urethane adhesives, vinyl alkyl ether adhesives, polyvinyl alcohol adhesives, polyvinyl pyrrolidone adhesives, polyacrylamide adhesives, and cellulose adhesives.

3. The polarizing plate according to claim 1, wherein the adhesive is formed of a composition comprising a (meth)acrylic copolymer and a cross-linking agent.

4. The polarizing plate according to claim 3, wherein the (meth)acrylic copolymer comprises a polymerization reaction product of a mixture comprising about 95 wt % to about 96 wt % of an alkyl group-containing (meth)acrylic monomer, about 2 wt % to about 3 wt % of a carboxylic acid group-containing (meth)acrylic monomer, and about 2 wt % to about 3 wt % of a hydroxyl group-containing (meth)acrylic monomer.

5. The polarizing plate according to claim 3, wherein the composition further comprises a silane coupling agent.

6. The polarizing plate according to claim 1, wherein the reinforcing material comprises a plurality of fibers or a fibrous network.

7. The polarizing plate according to claim 6, wherein each fiber of the plurality of fibers has a diameter of about 380 nm or less.

8. The polarizing plate according to claim 6, wherein the fibers comprise at least one selected from the group consisting of cellulose fibers, glass fibers, carbon fibers, cotton fibers, and carbon nanotube fibers.

9. The polarizing plate according to claim 1, wherein the reinforcing material comprises a cellulose sheet.

10. The polarizing plate according to claim 1, wherein the reinforcing material has a form of a sheet, particles, or a film.

11. The polarizing plate according to claim 1, wherein a ratio (NB) of a maximum length (A) of the reinforcing material to a length (B) of the adhesive sheet is about 1 or less.

12. The polarizing plate according to claim 1, wherein the adhesive sheet comprises: the reinforcing material; a first adhesive contacting an upper side of the reinforcing material; and a second adhesive contacting a lower side of the reinforcing material.

13. The polarizing plate according to claim 1, wherein the adhesive sheet has a thickness from about 3 μm to about 100 μm.

14. The polarizing plate according to claim 1, wherein the adhesive sheet comprises about 50 wt % to about 99.5 wt % of the adhesive, and about 0.5 wt % to about 50 wt % of the reinforcing material.

15. The polarizing plate according to claim 1, further comprising: a protective film stacked on an other surface of the polarizer facing away from the one surface of the polarizer.

16. The polarizing plate according to claim 15, wherein the protective film comprises celluloses, cyclic polyolefins, poly(meth)acrylates, polycarbonates, polyesters, polyethersulfones, polysulfones, polyamides, polyimides, polyolefins, polyarylates, polyvinyl alcohols, polyvinyl chlorides, polyvinylidene chlorides, or mixtures thereof.

17. The polarizing plate according to claim 1, wherein the adhesive sheet is configured to be on a liquid crystal panel.

18. An optical display comprising:
a liquid crystal panel; and
the polarizing plate according to claim 1 on the liquid crystal panel.
